(19) United States
(12) Patent Application Publication
(10) Pub. No.: US 2026/0071819 A1
(43) Pub. Date: Mar. 12, 2026

(54) Melting Furnace and Method for Melting a Metal Material

(71) Applicant: BAYERISCHE MOTOREN WERKE AKTIENGESELLSCHAFT, München (DE)

(72) Inventors: Franz BUCHAUER, Reisbach (DE); Markus SCHILLING, Ergoldsbach (DE)

(21) Appl. No.: 19/103,917

(22) PCT Filed: Aug. 7, 2023
(86) PCT No.: PCT/EP2023/071798

§ 371 Date: Feb. 14, 2025

(30) Foreign Application Priority Data
Aug. 19, 2022 (DE) 10 2022 121 002.2

(51) Int. Cl. F27B 1/22; F27B 1/08

(52) U.S. Cl. CPC F27B 1/22; F27B 1/08

(57) ABSTRACT

A melting furnace for melting a metallic material includes a receiving region for receiving the metallic material, a gas-burning device where the gas-burning device is disposed in the receiving region and where metallic material disposed in the receiving region is heatable and meltable by burning a gas by the gas-burning device, a heat-retention region, and an electrically operable heating device where a melt in the heat-retention region is able to be kept warm by the electrically operable heating device.

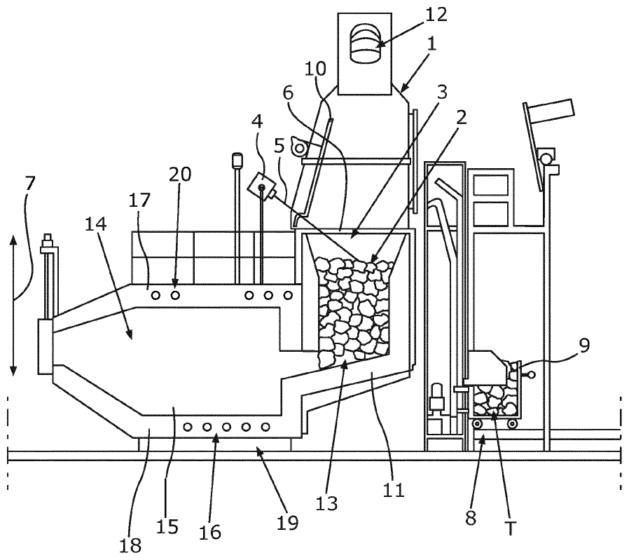

### BACKGROUND AND SUMMARY

The invention relates to a melting furnace for melting a metallic material. Furthermore, the invention relates to a method for melting a metallic material.

DE 103 25 153 A1 discloses an apparatus for melting and keeping warm metals, with a furnace for receiving a melt pool. Furthermore, DE 196 13 570 A1 discloses a method for the complete burning of CO-containing furnace gases in shaft melting furnaces. Furthermore, DE 1 199 794 B discloses a method for directly reducing iron ore.

It is an object of the present invention to provide a melting furnace and a method for melting a metallic material, such that particularly low-emission operation can be realized.

A first aspect of the invention relates to a melting furnace for melting a metallic material, i.e., a metal. This can be understood to mean that the melting furnace is suitable for melting different metals. However, the melting furnace is particularly preferably suited to melting aluminum. The melting furnace can thus be used to melt bodies which are formed from the metallic material and are initially solid, that is to say are initially in the form of solid bodies. For example, ingots formed from the metallic material can be melted by means of the melting furnace. For this purpose, the melting furnace comprises a receiving region in which the metallic material, in particular in a solid aggregate state of the metallic material and/or a liquid aggregate state of the metallic material, can be at least temporarily received. This should be understood in particular to mean that for example a first part of the material can be received in the solid aggregate state in the receiving region. As an alternative or in addition, it is for example possible for a second part of the material to be received in the liquid aggregate state in the receiving region. The receiving region is also referred to as charging region, since the metallic material is introduced in the solid aggregate state of the metallic material into the receiving region and can subsequently be at least temporarily received in the receiving region. The melting furnace also comprises a gas-burning device which is at least partially arranged in the receiving region and can be used to heat, and thereby melt, the material in the receiving region with burning of gas. In other words, it is for example possible for the mentioned gas to be fed as gaseous fuel to the gas-burning device, wherein the gas can be burned by means of the burning device, in particular in the burning device, in particular with formation of a flame and/or a burner exhaust gas. The flame and/or the burner exhaust gas may, for example, flow out of the gas-burning device and, in particular directly, into the receiving region, as a result of which the material arranged in the receiving region can be heated and subsequently melted in the receiving region.

The melting furnace also comprises a heat-retention region in which, for example, the material can be at least temporarily received in the liquid aggregate state of the material. It is also conceivable for a further, liquid material to be able to be at least temporarily received in the heat-retention region, the heat-retention region for example being filled or having been filled with the material, in particular via the receiving region and/or with bypassing of the receiving region. The further material is therefore also referred to as filled material. Again in other words, a liquid can be at least temporarily received in the heat-retention region, the liquid for example comprising the material in the liquid state of the material and/or the further material in the liquid state of the further material. In particular, by way of example, a melt which results from the melting of the material and is formed by the material, and thus a melt pool formed by the molten material, can be at least temporarily received in the heat-retention region. Thus, the mentioned liquid for example comprises a melt. In other words, the described melting of the material which takes place in the receiving region (charging region) liquefies the material, that is to say transforms it into a melt which can for example flow via at least one or exactly one fluidic connection between the receiving region and the heat-retention region from the receiving region into the heat-retention region. The melt can be collected in the heat-retention region and at least temporarily received in the heat-retention region so as to form a pool, which is also referred to as melt pool. For example, the fluidic connection between the receiving region and the heat-retention region is always, that is to say permanently, provided, with the result that for example the heat-retention region and the receiving region are permanently fluidically connected to one another. Thus, for example, a separating device which is able to switch between an open state, which fluidically connects the heat-retention region and the receiving region to one another and thus opens the fluidic connection between the heat-retention region and the receiving region, and a closed state, in which the receiving region and the heat-retention region are fluidically separated from one another, that is to say the fluidic connection between the receiving region and the heat-retention region is interrupted, is not provided, but rather, for example, the heat-retention region and the receiving region are permanently and thus always, that is to say constantly, fluidically connected to one another. It is also conceivable for the mentioned separating device which is able to switch between the closed state and the open state to be provided. In the closed state, the heat-retention region and the receiving region are not fluidically connected to one another by means of the separating device. In other words, the fluidic connection between the heat-retention region and the receiving region is interrupted in the closed state by means of the separating device. In the open state, the fluidic connection between the heat-retention region and the receiving region is formed, or the separating device opens the fluidic connection between the heat-retention region and the receiving region in the open state, with the result that the heat-retention region is fluidically connected to the receiving region in the open state. The heat-retention region and the receiving region are also referred to collectively as regions of the melting furnace.

In order to then be able to realize particularly low-emission operation of the melting furnace in particular with regard to CO2 emissions of the melting furnace, that is to say to be able to keep CO2 emissions of the melting furnace particularly low, the invention provides for the melting furnace to comprise a heating device which is operable electrically, that is to say using electrical energy or electrical current, and can be used to keep the melt in the heat-retention region warm using the electrical energy with which the heating device is operable or operated. In particular, it is provided that, by means of the heating device, the heat-retention region and thus the melt in the heat-retention region are heatable and, as a result, able to be kept warm. Usually, the melt in the heat-retention region is kept warm by means of a burner, in such a way that the burner, which may be a constituent part of the gas-burning device, burns gas. In this way, the burner for example provides a burner flame and/or an exhaust gas, the burner flame and/or the exhaust gas of the burner being introduced, in particular directly, into the heat-retention region in order to thereby keep the melt in the heat-retention region warm. Such gas-burning operation of such a burner can now be avoided by way of the invention since the melt can be kept warm by means of the electric heating device and thus using electrical energy in the or by way of the invention. The keeping warm of the melt should be understood in particular to mean that solidification of the liquid melt received in the heat-retention region does not occur, that is to say is prevented. Compared with conventional solutions, the invention makes it possible to avoid excessive CO2 emissions in particular in two respects. Firstly, in the case of a gas-operated burner which burns gas during its operation in order to for example keep the melt in the heat-retention region warm, CO2 is produced, which passes into the heat-retention region and/or is produced in the heat-retention region. This CO2 is usually removed by suction from the heat-retention region and/or from the receiving region and in particular constitutes a first part of CO2 emissions of conventional melting furnaces. A second part of the CO2 emissions of conventional melting furnaces is produced in particular due to the fact that, for the suction removal of CO2 from the heat-retention region and/or from the receiving region when the melt is being kept warm, a suction-removal means, which is also referred to as venting means, is operated, which is used, when the melt is being kept warm, to effect active suction removal of the CO2 from the heat-retention region and/or the receiving region. For this purpose, the suction-removal means is operated electrically, that is to say by means of electrical energy, this operation of the suction-removal means also producing CO2, which constitutes the aforementioned second part of the CO2 emissions of conventional melting furnaces. The invention now makes it possible to avoid both the CO2 emissions which result from operation of a gas burner for keeping the melt warm and the CO2 emissions which result from operation of a suction-removal means for the active suction removal of gas from the heat-retention region and/or from the receiving region when the melt is being kept warm. The invention thus enables operation of the melting furnace with particularly low CO2 emissions. The invention is particularly advantageous if the melting furnace is operated in heat-retention operation, during which the liquid melt received in the heat-retention region is kept warm by means of the heating device, but melting of material in the receiving region by means of the gas-burning device and thus burning of gas by the gas-burning device does not occur. In this heat-retention operation, it is for example possible for CO2 emissions of the melting furnace to be kept particularly low, in particular compared with conventional solutions. The invention is in particular based on the recognition that, firstly, electric heating devices are not suitable for melting the metallic material. For this, compared with the melting of the metallic material by means of the gas-burning device and thus using gas, a very high electrical power would be required, which would result in higher CO2 emissions than the melting of the metallic material by means of gas, that is to say by means of the gas-burning device. Secondly, the electric heating device is particularly advantageously suitable for keeping the liquid melt in the heat-retention region warm, and specifically preferably without the melt in the receiving region being kept warm by a gas burner, that is say by burning of gas. The invention thus combines the advantages of the gas-burning device, thus of the heating device. By means of the gas-burning device, the metallic material such as aluminium ingots can be melted in melting operation in an energetically advantageous manner, that is to say in a manner that is particularly favorable in terms of efficiency. By means of the electric heating device, the melt which is for example in the form of liquid aluminum or formed as liquid aluminum can be kept warm in an energy-efficient manner in the heat-retention region, with the result that overall particularly low-emission operation of the melting furnace can be realized. The aforementioned heat-retention operation occurs, for example, during production downtime of a casting plant comprising the melting furnace, for example during a weekend and/or during maintenance work. During such periods, no melt and thus no melting of metallic material is required. A combination of the electric heating device, which is also referred to as electric heater, with the gas-burning device makes it possible to realize very energy-saving operation of the melting furnace, in particular in the heat-retention operation, which is also referred to as heat-retention mode.

In order to be able to keep the liquid melt in the heat-retention region warm in a particularly energy-efficient manner by means of the heating device, such that particularly low-emission operation of the melting furnace can be ensured, one embodiment of the invention provides that the heat-retention region, in particular in relation to a position of use of the melting furnace, is at least partially overlapped upward and/or downward in a vertical direction by the electric heating device. The position of use of the melting furnace is a position of the melting furnace that is provided for an intended use of the melting furnace and that is used during intended use of the melting furnace in order to melt the metallic material and to keep the melt in the heat-retention region warm.

A further embodiment is distinguished by the fact that the heating device is arranged on or in a base of the melting furnace, the base downwardly delimiting the heat-retention region in the vertical direction, in particular in relation to the position of use of the melting furnace. This makes it possible to ensure particularly energy-efficient operation of the melting furnace, in particular in the heat-retention operation.

It is conceivable for the melt in the heat-retention region to be kept warm by means of the heating device in the heat-retention operation. It is also conceivable for the melt in the heat-retention region to not be kept warm by the electric heating device in the melting operation, or for the melt in the heat-retention region to be kept warm by means of the heating device in the melting operation.

A further, particularly advantageous embodiment of the invention provides for the heating device to be arranged on or in a cover of the melting furnace, the cover upwardly delimiting the heat-retention region in the vertical direction, in particular in relation to the position of use of the melting furnace. It has been found that the arrangement of the heating device in or on the cover is particularly advantageous for realizing particularly energy-efficient operation of the heating device, that is to say for being able to keep the melt in the heat-retention region warm in a particularly energy-efficient manner.

For example, the electric heating device comprises at least one heating element, in particular as first heating element, the heating element being arranged for example on or in the base or on or in the cover.

In order to be able to realize particularly low-emission operation of the melting furnace and keep the costs of the melting furnace within a particularly low scope, a further refinement of the invention provides for the melting furnace to be free from a gas burner for the direct heating of the heat-retention region. Such a gas burner for the direct heating of the heat-retention region should be understood in particular to mean a burner which burns gas, that is to say a gaseous fuel, during its operation and, as a result, provides a flame and/or an exhaust gas, which is conducted directly into the heat-retention region.

A further embodiment is distinguished by the fact that the heating device comprises at least one resistance heating element for heating the heat-retention region. In particular, the resistance heating element may be the aforementioned heating element. This makes it possible for the heat-retention region to be kept warm in a particularly energy-efficient manner and thus with low CO2 emissions.

Lastly, it has been shown to be particularly advantageous if the receiving region and the heat-retention region are embodied as a unit which cannot be separated without destruction. This means, for example, that the receiving region and the heat-retention region are formed by housing parts which are for example formed separately from one another and fixedly connected to one another, that is to say so as to not be detachable without destruction, and thus form the unit, or the housing parts are formed in one piece with one another, that is to say formed from a single piece. Thus, emptying of the melt or of the heat-retention region, that is to say discharging of the melt from the heat-retention region, can be effected only concertedly by tilting of the entire melting furnace, that is to say by concerted tilting of the receiving region and of the heat-retention region, or by pumping out, in particular of the heat-retention region.

A second aspect of the invention relates to a method for melting a metallic material by means of a melting furnace, in particular according to the first aspect of the invention. In the method, the melting furnace comprises a receiving region, which is also referred to as charging region. In the receiving region, the metallic material is at least temporarily received in a solid aggregate state of the metallic material. The melting furnace comprises a gas-burning device which is arranged in the receiving region and is used to heat, and thereby melt, the material in the receiving region with burning of gas. This should be understood in particular to mean that the mentioned gas is burned as gaseous fuel by means of the gas-burning device, in particular in the gas-burning device and most particularly in a chamber of the gas-burning device, as a result of which, for example, the gas-burning device provides an exhaust gas and/or a flame. The exhaust gas provided by the gas-burning device and/or the flame provided by the gas-burning device are/is conducted, in particular directly, into the receiving region in order to thereby heat and subsequently melt the material in the receiving region. In the method, the melting furnace comprises a heat-retention region in which a melt, which results from the melting of the material and is formed by the material, is received.

The melting furnace may, for example, be in the form of a shaft melting furnace or alternatively in the form of a ramp furnace or in the form of another furnace, that is to say in the form of another apparatus for melting the metallic material.

In order to then be able to realize particularly low-emission operation of the melting furnace in particular with regard to CO2 emissions of the melting furnace, the second aspect of the invention provides for the melting furnace to comprise an electrically operable heating device which is used to keep the melt in the heat-retention region warm using electrical energy with which the heating device is supplied, as a result of which the heating device is electrically operated. Advantages and advantageous refinements of the first aspect of the invention can be considered to be advantages and advantageous refinements of the second aspect of the invention and vice versa.

In order to be able to realize particularly low-emission operation of the melting furnace, one embodiment of the second aspect of the invention provides for the melting furnace to be operated in a, or the aforementioned, heat-retention operation. In the heat-retention operation, the melt is kept warm by means of the electric heating device, which is electrically operated in the heat-retention operation, whilst burning operation of the gas-burning device, in the burning operation of which the gas-burning device burns gas and, as a result, heats the material in the receiving region, does not occur. It is thus preferably provided that, in the heat-retention operation, the gas-burning device burns no gas and subsequently does not heat the material in the receiving region. As a result, excessive CO2 emissions of the melting furnace can be avoided in particular during production downtime.

In order to be able to realize particularly low-emission operation of the melting furnace, it is provided in a further refinement of the invention that, during the heat-retention operation, active suction removal of gas from the heat-retention region or from the receiving region does not occur. The background for this embodiment is the fact that, in the heat-retention operation, the burning device burns no gas, produces no CO2 and no CO2-containing gas which must be removed by suction from the receiving region or the heat-retention region. In the heat-retention operation, active suction removal of CO2 from the heat-retention region or from the receiving region can therefore be omitted, as a result of which particularly energy-efficient operation of the melting furnace is conceivable.

Lastly, it has been shown to be particularly advantageous if the melting furnace is operated in a, or the aforementioned, melting operation, in which the gas-burning device is operated in the burning operation. In the burning operation, the gas-burning device burns gas, as a result of which the gas-burning device heats and melts the material in the receiving region. Meanwhile, a suction-removal device is operated, in particular electrically, as a result of which active suction removal of gas and thus CO2 from the receiving region and/or from the heat-retention region is effected by means of the suction-removal device of the melting furnace. As a result, reliable operation can be realized, and, as described above, the metallic material can be melted in a particularly energy-efficient manner by means of the gas-burning device. As a result, in particular considering the melting operation and the heat-retention operation together, operation of the melting furnace with particularly low CO2 emissions can be ensured.

Further details of the invention will emerge from the description below of a preferred exemplary embodiment with the associated drawing.

### BRIEF DESCRIPTION OF THE DRAWING

The single Figure shows a schematic and sectional side view of a melting furnace for melting a metallic material.

### DETAILED DESCRIPTION OF THE DRAWING

The single Figure shows a schematic and sectional side view of a melting furnace 1 for melting a metallic material 2. In the exemplary embodiment shown in the Figure, the melting furnace 1 is in the form of a shaft melting furnace. However, the statements made above and below can self-evidently and readily also be applied to other apparatuses for melting a metallic material, such as the metallic material 2.

The melting furnace 1 comprises a receiving region 3, which is also referred to as charging region, in which the metallic material 2 can be or is received in a solid aggregate state of the metallic material 2. The Figure shows, in particularly schematic form, a detection device 4 which can be used to detect a fill level of the metallic material 2 in the receiving region 3, that is to say a measured variable which characterizes a quantity of the material 2 arranged in the receiving region 3. In the exemplary embodiment shown in the Figure, the detection device 4 is in the form of a laser detection device, by means of which a laser beam 5 can be or is provided. The mentioned measured variable is detected by means of the laser beam 5. In particular, the measured variable is a height, which is also referred to as fill level, of the material 2 in the receiving region 3, in particular in relation to a predefined or predefined starting height or in relation to a predefinable or predefined starting level. In the exemplary embodiment shown in the Figure, the receiving region 3 is a shaft. The receiving region 3 itself has an opening 6, the receiving region 3 itself being open upwardly in the vertical direction in particular by way of the opening 6. The vertical direction is illustrated by a double arrow 7. For example, the melting furnace 1 is operated, in particular in melting operation and/or in heat-retention operation of the melting furnace 1, in dependence on the measured variable detected by means of the detection device 4.

The melting furnace 1 also comprises a charging device 8 which can be used to, in particular automatically, fill the receiving region 3 with the material 2 from outside the receiving region 3. For this, it is for example possible for a portion, denoted by T, of the material 2 to be arranged in a movement element 9, which is for example in the form of an elevator, and to be introduced, in particular filled, into the receiving region 3 from outside the receiving region 3 by means of the movement element 9.

The opening 6, which is in the form of a passage opening, is arranged on a side of the receiving region 3 that points upward in the vertical direction (double arrow 7), as a result of which the receiving region 3 itself is open upwardly in the vertical direction. The opening 6 is assigned a flap 10. The receiving region 3 and the opening 6 are delimited, in particular directly, by a housing 11 of the melting furnace 1. In this case, the flap 10 is retained on the housing 11 so as to be movable, in particular pivotable, relative to the housing 11, in particular in such a way that the flap 10 is movable relative to the housing 11 between an open position, shown in the Figure, and a closed position. In the open position, the flap 10 opens the opening 6, with the result that the material 2 can be introduced, in particular filled, into the receiving region 3 via the opening 6 in the open position. In the closed position, the opening 6 and thus the receiving region 3 are closed upwardly in the vertical direction by means of the flap 10.

The melting furnace 1 also comprises a suction-removal device 12, which is also referred to as venting device and will be explained in more detail below. Furthermore, the melting furnace 1 comprises a gas-burning device 13 which is arranged in the receiving region 3 and can be used to heat, and thereby melt, the material 2 in the receiving region 3 with burning of gas. The feature that the material 2 in the receiving region 3 is heatable, and thereby meltable, by means of the gas-burning device 13 with burning of gas should be understood to mean that the mentioned gas is burned as gaseous fuel by means of the gas-burning device 13, in particular in at least one burning chamber of the gas-burning device 13. This results in heat, which is provided for example by the gas-burning device 13. The material 2 is heated, and thereby melted, by means of the heat. For example, the burning of the gas results in an exhaust gas and/or a flame, which is for example discharged from the gas-burning device 13 and introduced, in particular directly, into the receiving region 3. As a result, the material 2 in the receiving region 3 is heated and subsequently melted.

The gas-burning device 13 is at least partially arranged in the receiving region 3. The melting furnace 1 also comprises a heat-retention region 14 in which a melt 15, which results from the melting of the material 2 and is formed by the material 2, can be or is at least temporarily received.

In order to then be able to realize operation of the melting furnace 1 with particularly low CO2 emissions, the melting furnace 1 comprises an electrically operable heating device 16 which can be used to keep the melt 15 in the heat-retention region 14 warm using electrical energy. This means that the heating device 16 is supplied with electrical energy, by means of which the heating device 16 is electrically operated. In this way, the heating device 16 provides heat which keeps the melt 15 in the heat-retention region 14 warm and, as a result, keeps it in particular in a liquid aggregate state of the melt 15.

It can be seen that the heat-retention region 14 is delimited upward in the vertical direction, in particular directly by a cover 17 of the melting furnace 1, in particular of the housing 11. The heat-retention region 14 is delimited downward in the vertical direction, in particular directly, by a base 18 of the melting furnace 1, in particular of the housing 11. The heating device 16 for example comprises heating elements 19 which are in particular in the form of heating rods and are arranged in the base 18. As an alternative or in addition, the heating device 16 for example comprises heating elements 20 which are in particular in the form of heating rods and are arranged in the cover 17. The heating elements 19, 20 are for example resistance heating elements which can be used to keep the heat-retention region 14 and thus the melt 15 arranged in the heat-retention region 14 warm in a particularly advantageous, in particular particularly energy-efficient, manner.

The metallic material 2 is, for example, aluminum which is present in its solid aggregate state in the form of aluminum ingots in the receiving region 3.

The melting furnace 1 is free from a gas burner for the direct heating of the heat-retention region 14, such that a particularly cost-effective construction and particularly low-emission operation of the melting furnace 1 can be realized.

In a method for operating the melting furnace 1, the melting furnace 1 is operated in the aforementioned heat-retention operation. In the heat-retention operation, the melt 15 in the heat-retention region 14 is kept warm by means of the electric heating device 16, whilst burning operation of the gas-burning device 13 does not occur. In the burning operation of the gas-burning device 13, gas is burned in the gas-burning device 13 and, as a result, the material 2 in the receiving region 3 is heated. It is preferably also provided that, in the heat-retention operation, active suction removal of gas from the heat-retention region 14 or from the receiving region 3 does not occur.

For example, before the heat-retention operation and/or after the heat-retention operation, the melting furnace 1 is operated in the aforementioned melting operation. In the melting operation, the gas-burning device 13 is operated in the burning operation, in which the gas-burning device itself burns gas and, as a result, heats and melts the material 2 in the receiving region 3, whilst active suction removal of gas, and thus CO2 resulting for example from the burning operation, from the receiving region 3 and for example via the receiving region 3 from the heat-retention region 14 is effected by means of the suction-removal device 12. For this, the suction-removal device 12 is operated by means of electrical energy by virtue of the suction-removal device 12 being supplied with the electrical energy. For example, in the melting operation, the flap 10 is opened, that is to say the flap 10 is in its open position in the melting operation. In the heat-retention operation, the flap 10 is for example closed, that is to say the flap 10 is then in the closed position. In particular, the melting furnace 1, which is also referred to simply as furnace, can operate, in particular control or regulate, itself. When, for example, the flap 10 is opened, the melting furnace 1 is operated in the melting operation. If, for example, the flap 10 is closed, since no material in the receiving region 3 is intended to be melted, there is a switch from the melting operation to the heat-retention operation. Consequently, CO2 emissions of the melting furnace 1 can be kept particularly low. In particular, it is provided that melting of material in the receiving region 3 by means of the electric heating device 16 does not occur. This can ensure particularly energy-efficient operation.

The melting furnace 1 is for example a constituent part of a smelter, in particular of an aluminum smelter. In particular, the melting furnace 1 may be a constituent part of a foundry, in which structural elements are produced by casting from the melt 15. Thus, particularly low-emission operation of the smelter or of the foundry overall is conceivable.

### LIST OF REFERENCE CHARACTERS

1 Melting furnace
2 Metallic material
3 Receiving region
4 Detection device
5 Laser beam
6 Opening
7 Double arrow
8 Charging device
9 Movement device
10 Flap
11 Housing
12 Suction-removal device
13 Gas-burning device
14 Heat-retention region
15 Melt
16 Electric heating device
17 Cover
18 Base
19 Heating elements
20 Heating elements
T Portion

1.-11. (canceled)

12. A melting furnace for melting a metallic material, comprising:
a receiving region for receiving the metallic material;
a gas-burning device, wherein the gas-burning device is disposed in the receiving region and wherein metallic material disposed in the receiving region is heatable and meltable by burning a gas by the gas-burning device;
a heat-retention region; and
an electrically operable heating device, wherein a melt in the heat-retention region is able to be kept warm by the electrically operable heating device.

13. The melting furnace according to claim 12, wherein the heat-retention region is at least partially overlapped upward and/or downward in a vertical direction by the electrically operable heating device.

14. The melting furnace according to claim 12, wherein the heating device is disposed on or in a base of the melting furnace and wherein the base downwardly delimits the heat-retention region in a vertical direction.

15. The melting furnace according to claim 12, wherein the heating device is disposed on or in a cover of the melting furnace and wherein the cover upwardly delimits the heat-retention region in a vertical direction.

16. The melting furnace according to claim 12, wherein the melting furnace is free from a gas burner for a direct heating of the heat-retention region.

17. The melting furnace according to claim 12, wherein the heating device comprises at least one resistance heating element for heating the heat-retention region.

18. The melting furnace according to claim 12, wherein the receiving region and the heat-retention region are embodied as a unit which cannot be separated without destruction.

19. A method for melting a metallic material by a melting furnace, comprising the steps of:
receiving the metallic material in a solid aggregate state of the metallic material in a receiving region;
heating, and thereby melting, the metallic material in the receiving region by a gas-burning device which is disposed in the receiving region by burning a gas;
receiving a melt which results from the melting of the metallic material and is formed by the metallic material in a heat-retention region; and
keeping the melt warm in the heat-retention region by an electrically operable heating device.

20. The method according to claim 19, wherein the melting furnace is operated in a heat-retention operation in which the melt is kept warm by the electrically operable heating device and wherein in the heat-retention operation the gas-burning device does not burn the gas.

21. The method according to claim 20, wherein during the heat-retention operation, active suction removal of the gas from the heat-retention region or from the receiving region does not occur.

22. The method according to claim 19, wherein the melting furnace is operated in a melting operation in which the gas-burning device is operated in a burning operation in which the gas-burning device burns the gas and, as a result, heats and melts the metallic material in the receiving region, while active suction removal of the gas from the receiving region and/or from the heat-retention region is effected by a suction-removal device of the melting furnace.
